(19) United States
(12) Patent Application Publication
(10) Pub. No.: US 2019/0303140 A1
(43) Pub. Date: Oct. 3, 2019

(54) SOURCE CODE PEER REVIEW MATCHMAKING

(71) Applicant: CA, Inc., Islandia, NY (US)

(72) Inventor: Ian Aloysious Kelly, Colleyville, TX (US)

(73) Assignee: CA, Inc., Islandia, NY (US)

(21) Appl. No.: 15/941,228

(22) Filed: Mar. 30, 2018

(51) Int. Cl. G06F 8/75; G06Q 10/06; G06N 3/08; G06K 9/62

(52) U.S. Cl. CPC G06F 8/75; G06K 9/6282; G06N 3/08; G06Q 10/063112

(57) ABSTRACT

A request is received for a computing system to automatically identify a peer reviewer for a particular source code component. A copy of the particular source code component is accessed from computer memory and analyzed to determine a set of characteristics of the particular source code component. A plurality of other source code components are analyzed, where were authored by a plurality of other users to determine a particular one of the other users as authoring source code with characteristics similar to the set of characteristics. Data is generated to identify selection of the particular user as a peer review candidate for reviewing the particular software component.

### BACKGROUND

The present disclosure relates in general to the field of computer system development, and more specifically, to machine learning techniques to identify similarity between software development coding projects.

Modern software systems often include multiple programs or applications working together to accomplish a task or deliver a result. For instance, a first program can provide a front end with graphical user interfaces with which a user is to interact. The first program can consume services of a second program, including resources of one or more databases, or other programs or data structures. Software programs may be written in any one of a variety of programming languages, with programs consisting of software components written in source code according to one or more of these languages. Development environments exist for producing, managing and compiling these programs. In software development, peer review may be utilized to have the developer and one or more other persons (e.g., colleagues of the developer) examine the work product (e.g., documentation, code, etc.), in order to evaluate its technical content and quality. Peer reviewing coding projects may thereby lead to the detection and correction of defects in software artifacts, thereby preventing the leakage of such issues into production level products and services, where detection and correction may be more complicated and costly.

### BRIEF SUMMARY

According to one aspect of the present disclosure, a request may be received for a computing system to automatically identify a peer reviewer for a particular source code component. A copy of the particular source code component may be accessed from computer memory and analyzed to determine a set of characteristics of the particular source code component. A plurality of other source code components are analyzed, which were authored by a plurality of other users to determine a particular one of the other users as authoring source code with characteristics similar to the set of characteristics. A particular one of these other users is selected as a peer review candidate for reviewing the particular software component.

### BRIEF DESCRIPTION OF THE DRAWINGS

FIG. 1 is a simplified schematic diagram of an example computing system including an example software development system in accordance with at least one embodiment;

FIG. 2 is a simplified block diagram of an example computing system including an example peer review selection system in accordance with at least one embodiment;

FIG. 3 is a simplified block diagram illustrating aspects of the autonomous selection of candidate peer reviewers for code components in accordance with at least one embodiment;

FIGS. 4A-4B are simplified block diagrams illustrating example stages in the autonomous selection of candidate peer reviewers for code components in accordance with at least one embodiment;

FIG. 5 is a simplified block diagram illustrating aspects in an example code correlation in accordance at least some embodiments;

FIG. 6 is a simplified flowchart illustrating example techniques for performing autonomous selection of a peer review candidate for a particular code component in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

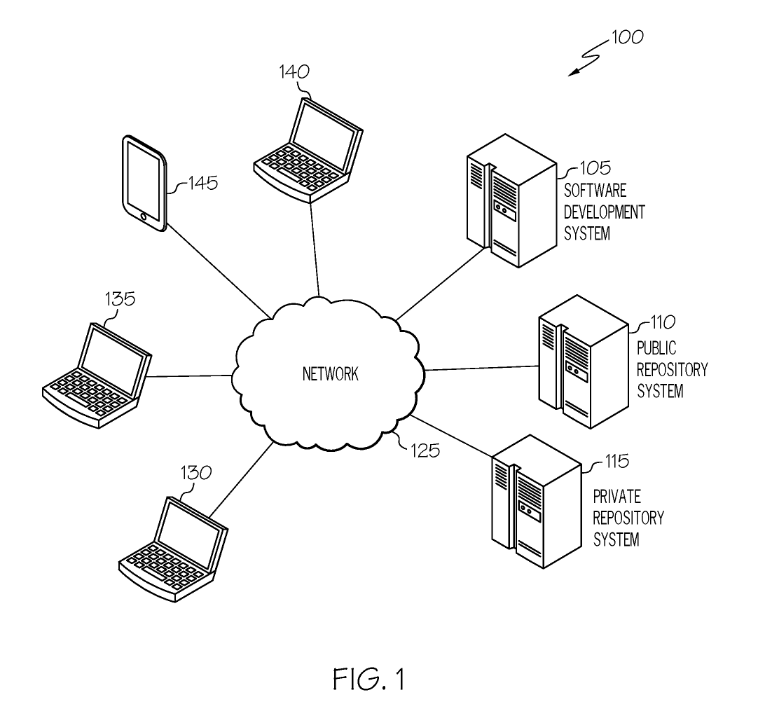

Referring now to FIG. 1, a simplified block diagram is shown illustrating an example computing environment 100 including an example software development system 105, which may host software development tools, such as an integrated development environment (IDE), and other tools for use in drafting source code to develop new software components and applications. In some implementations, a software development system 105 may interface with, be integrated with, or otherwise make use of services, data, and code provided through one or more repository systems (e.g., 110, 115). Repository systems (e.g., 110) may include and implement repositories which are public, such that the repositories provide open source or shared software components together with management of changes within these components. An example repository system (e.g., 115) may also host and manage private repositories, such as an enterprise repository system or repository for a particular software development firm (e.g., to balance the privacy of the code being developed by such an enterprise (which may be of extreme importance) with developer collaboration within the enterprise through the repository system). In some cases, a repository system (e.g., 110, 115) may host and manage both public and private repositories, among other examples.

In some implementations, an example software development system may be enhanced with functionality to automatically match users to developers of a respective coding project to perform peer review tasks relating to the project. Indeed, for any one of a variety of coding projects, an example software development system 105 may intelligently determine (e.g., using machine learning) candidates, which may be most qualified to effectively peer review source code of a project. While organizations traditionally rely on seniority or pre-determined peer review assignments based on titles or roles defined within the organization, an improved software development system 105 may leverage computer logic to assess a source code component (e.g., a piece of code, code segment, module, or program) to identify the characteristics of the source code used in the component and custom select, based on the unique characteristics of the component, one or more peer review candidates based on these candidates' experience with similar projects. This may facilitate the selection of peer reviewers who are better positioned to both more quickly and accurately interpret and understand the source code of the component and provide product insights and improvements to the components, among other example advantages. In some instances, other source code components, such as source code stored and maintained in connection with project repositories hosted by one or more repository systems (e.g., 110, 115) may be mined by the software development system 105 to determine peer review candidates best suited to handling peer review duties for a particular source code component, among other example uses and implementations.

An example software development system 105 may connect to and interface with other systems over one or more networks (e.g., 125), including repository systems (e.g., 110, 115) and other systems in connection with autonomously determining peer review candidates matched to a particular coding project. In some cases, the software development system 105 may provide development tools and peer review matchmaking as services (e.g., a cloud-based application), allowing remote client devices (e.g., 130, 135, 140, 145) to access the system 105 through a web browser or other interface and generate new coding projects to be developed and managed through the software development system 105. Likewise, repository systems (e.g., 110, 115) may provide repository services to various clients and customers. Various client devices (e.g., 130, 135, 140, 145) may allow users interface to interface and use these services and system, through connections over one or more networks (e.g., 125), included wired and wireless networks, private and public networks, and combinations thereof.

In general, “servers,” “clients,” “computing devices,” “network elements,” “database systems,” “user devices,” and “systems,” etc. (e.g., 105, 110, 115, 130, 135, 140, 145, etc.) in example computing environment 100, can include electronic computing devices operable to receive, transmit, process, store, or manage data and information associated with the computing environment 100. As used in this document, the term “data processing apparatus,” “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 130, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, software development system 105, repository systems (e.g., 110, 115), or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

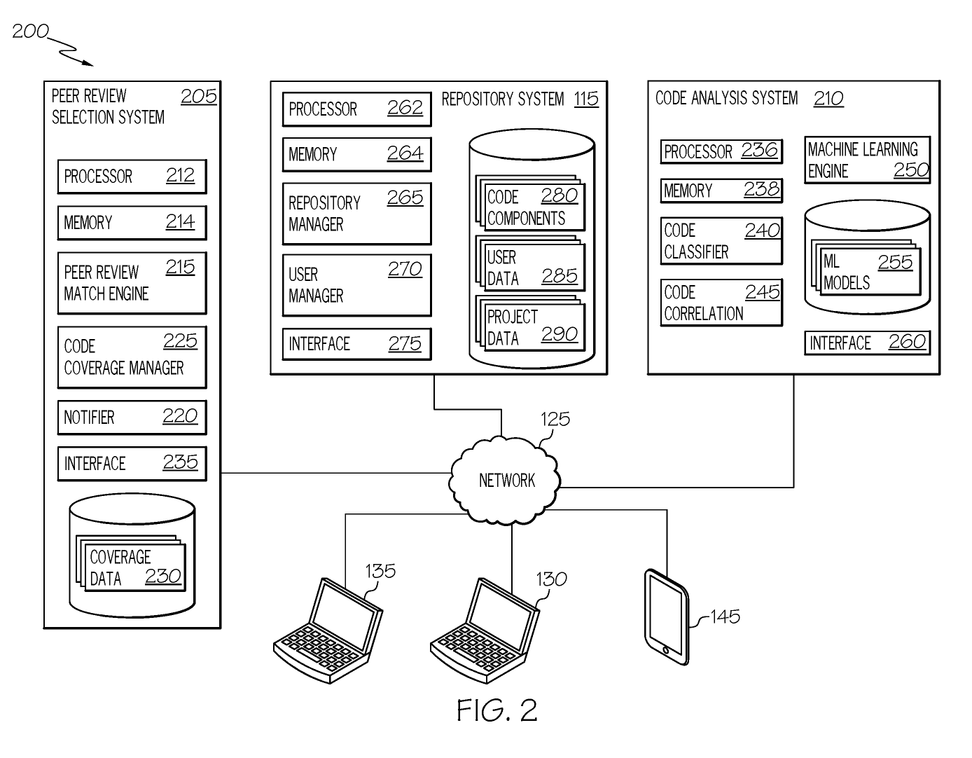

Turning to the example of FIG. 2, a simplified block diagram 200 is shown illustrating an example environment including an enhanced implementation of an example software development system. For instance, a peer review selection system (e.g., 205) may be provided in connection with (or separate from) an example software development system providing conventional software development and editing tools and services. The peer review selection system 205 may operate in concert with a code analysis system 210 to determine optimal peer reviewer candidates for various source code components in the system. In some cases, a peer review selection system 205 and code analysis system 210 may be provided together in the same integrated system. In other implementations, the peer review selection system 205 and code analysis system 210 may be provided as separate systems, among other example system implementations (such as implementations combining the functionality of peer review selection system 205 and code analysis system 210 with repository system 115).

In one example, a peer review selection system 205 may include one or more data processing apparatus (e.g., 212) and one or more memory elements 214 for use in implementing executable modules, such as a peer review match engine 215, code coverage manager 225, and notification engine 220, among other example components. The peer review selection system 205 may additional include one or more interfaces 235 (e.g., application programming interfaces (APIs) or other interfaces), which may be used to communicate with and consume data and/or services of various outside systems, such as a repository system (e.g., 115), code analysis system (e.g., 210), among other examples.

In one example, an example peer review match engine 215 may include functionality to mine a collection of software code components (e.g., 280) to identify similarities between the source code of these components and that of a subject software component. Based on these and other similarities determined by the peer review match engine 215 a set of one or more potential peer review candidates may be identified who authored or were in other ways involved in the development of software code components determined to be similar to the subject software component. Other considerations may also be weighed by the peer review match engine 215 when making a recommendation of a peer reviewer for a particular software code. For instance, peer review selection system 205 may additionally include a code coverage manager 225.

In some instances, it may be a goal of an organization to expose its developers to as much of the code base of a particular project or product, a set of projects, or all of the projects and products of the organization. Accordingly, a code coverage manager 225 may measure individual developers' exposure to source code of various projects or products within a designated code base (e.g., as described and defined within coverage data 230). The code coverage manager 225 may additionally identify gaps in individual developers' exposure to the code base. As an example, coverage data 230 may document the various experience and exposure each user to code within the system. Further, coverage data 230 may define aspects of the code to assist in measuring and facilitating users' exposure to the code base. For instance, categories of code and projects may be defined within the code base. It may not be practical to expect each developer to have exposure to or be familiar with every source code component in a system, accordingly categories may provide opportunities to gain exposure to source code on a category basis, for instance, with code organized by its purpose or general functionality, based on its inclusion in a particular application or software component, based on a particular team or business unit responsible for or otherwise associated with the code component, among other example categories. Serving as a peer reviewer may provide an excellent way for an individual developer to gain exposure to a portion of a defined code based. Accordingly, the code coverage manager 225 may identify that a particular subject code component offers the opportunity for one or more users to also fill a gap in their code base exposure. Such findings may be communicated from the code coverage manager 225 to the peer review match engine 215, which the peer review match engine 215 may additional consider in recommending potential peer reviewers for the subject code component, among other example interactions, uses, and implementations.

In some implementations, a peer review match engine 215 may identify a group of users as candidate peer reviewers for a given code component. The peer review match engine 215 may select a single one of the identified candidates and may request that an assignment be generated to pair the identified peer reviewer with other user-developers responsible for developing the subject code component. In some implementations, a notification engine (e.g., 220) may be provided, which may receive a peer reviewer match result from the peer review match engine 215 and identify contact information corresponding to the identified peer reviewer, as well as the owners of the code component to be reviewed. The notification engine 220 may generate a corresponding electronic message to notify the parties and, in some cases, generate a formal assignment of peer review for the identified peer reviewer. In some implementations, additional subsystems may be provided to track and manage progress of an assigned peer review based on the recommendation of the peer review match engine 215, among other example features and implementations. notification and determine that a particular subject code component represents an opportunity to gain exposure within

As noted above, an example peer review match engine 215 may base peer review match recommendations on detected similarities between a subject code component and the code components authored or managed by various other users in an organization. In some implementations, a code analysis system 210 may be provided to interface with the peer review match engine 215 (e.g., through interfaces 235, 260) and provide information identifying other code components, which are similar to a subject code component. In one example, code analysis system 210 may include one or more data processing apparatus (e.g., 236) and one or more memory elements 238 for use in implementing executable modules, such as a code classifier 240, code correlation engine 245, a machine learning engine 250 (which may include specialized machine learning hardware, such as a tensor processing unit, matrix processing unit, specialized graphics processing unit, among other examples), and other example subsystems. A code analysis system 210 may additional include an interface 260 through which the code analysis system 210 may communicate with other systems (e.g., systems 115, 205, etc.).

In one example, a code classifier 240 of a code analysis system 210 may provide functionality for processing or analyzing a particular code component. The particular code component may be the subject of a peer review matchmaking performed using peer review selection system 205. In some cases, a copy of the particular code component may be furnished in connection with a request to identify a peer reviewer for the particular code component. In one example, the code classifier may accept the copy of the particular code component as an input and analyze the particular code component to autonomously identify various characteristics of the particular code component. For instance, the code classifier 240 may autonomously identify such characteristics as a programming language used in the particular code component, a programming style used in the particular code component, naming or commenting conventions used in the code, among other examples. Some types of characteristics may be determined by the code classifier 240 using data parsing to parse the source code of the code component to identify particular comments, definitions, language constructs, etc. that may explicitly or implicit identify these characteristics. Other characteristics may be more nuanced and difficult to identify autonomously using a computer-implemented code classifier. For instance, characteristics relating to programming style and functionality of the code may not be immediately discoverable by parsing terms in the source code. Instead, in some implementations, the code classifier may utilize machine learning models (e.g., 255) such as artificial neural networks (e.g., convolutional neural networks, spiking neural networks, etc.), random forest models, support vector machines, among other examples, which may be applied by a machine learning engine 250 to identify that the subject code component possesses a particular characteristic in various characteristic types (e.g., a particular programming style in a programming style characteristic type), among other examples.

The set of characteristics determined for a particular code component may be used by a code correlation engine 245 to assess a library of other code components 280 (e.g., authored by other developers) to identify other code components with similar characteristics. In some implementations, to limit the corpus of other code components to be assessed for similarities with the particular code component, the other code components can be filtered by a code correlation engine 245 to remove consideration of any other code components authored by the same developer or team responsible for development of the particular code component, among other example filters and enhancements. In some cases, a corpus of code components may be filtered based on one or more of the characteristics determined for the particular code components. For instance, a repository or other organization of other code components (e.g., 280) may be indexed based on some categories of characteristics, such as the language used in the respective code component, a business unit, product, or macro-level project of which the code component is a part or otherwise associated, among other examples.

Finding other code components with characteristics similar to other types of characteristics determined by the code classifier 240 may be more difficult to determine. For instance, a code correlation engine 245, in some implementations, may also make use of machine learning models 255 and algorithms performed using one or more machine learning engines (e.g., 250). In some implementations, the combination of characteristics determined for a particular code component may be expressed as a feature vector. The feature vector may be provided, to the code correlation engine 245 to determine (and in some cases rank) other code components (e.g., 280) similar to subject code component. In some cases, the feature vector may be applied as an input to a neural network, decision tree random forest, or other machine learning model to identify similar code components, among other example implementations.

Results generated by a code correlation engine 245 may be provided to an example peer review selection system 205 for consideration in determining peer review candidates for a subject piece of code, or code component. The peer review selection system 205 may identify a set of code components determined by the code correlation engine 245 to be similar to the subject code. The peer review selection system 205 may additionally consider other attributes when determining a set of similar code components. For instance, the peer review selection system 205 may emphasize other code components, which reinforce a coding skill, coding style, or code structure which the author of the subject code has recently acquired or is in the process of mastering (e.g., as detected from the subject code itself or from metadata describing attributes of the subject code's developer). In some instances, a set of similar code components may be selected based on the set's ability to influence the author of the subject code to develop new skills, styles, or habits (e.g., according to preferences of a particular organization) or to provide exposure to code components, which include solutions to issues or bugs found to exist in the subject code's author's code (e.g., based on historical information from the user (e.g., documented in user data 285)), among other example considerations. Similarities and peer reviewer selection based on one or more of these example characteristics may be determined using computer-implemented heuristic analysis, machine learning, and other autonomously performed techniques of a computer.

Upon identifying a set of similar code components, the peer review selection system 205 may access data mapping this set of similar code components to persons responsible for these similar components, such as developers of these similar code components. In some implementations, a peer review selection system 205 may utilize information from one or more other systems, such as one or more repository systems (e.g., 115) to generate or access user data 285 and/or project data 290 to determine mappings between the similar code components and particular users. As noted above, a peer review selection system 205 may also consider potential peer reviewers' respective code coverage exposure when selecting a user as a peer reviewer. In some cases, a code coverage exposure analysis can make use of data from other systems, such as repository data (e.g., user data 285 and project data 290) hosted by a repository system (e.g., 115) to identify code coverage mappings (e.g., to determine that a subject piece of code would qualify as exposure to a particular portion of the code base) and identify individual users' exposure (and gaps in exposure) to categories of code within the code base, among other examples. Indeed, code coverage data (e.g., 230) may be generated from repository data and data or other systems corresponding to the code base.

The peer review selection system 205 may additionally consider other characteristics (e.g., described in example user data 285, project data 290, or other data) when scoring, ranking, or otherwise identifying potential peer reviewers for a particular coding project. For instance, a concept or experience journey may defined for an author of the subject code, which corresponds to the development of the author's experience and skills in a particular language, organization, or software development generally. Peer reviewer candidates may be identified, who share similar paths in their respective experience journey, or who have particular expertise in an area where the subject code's developer is deficient or an area corresponding to the next step in the subject code developer's journey. Side and personal projects corresponding to the developer of the subject code may be considered, together with those of potential peer reviewer candidates. Additional similarities and characteristics may be detected, such as connectivity of previous work outcomes and the type of work corresponding to the subject code. Previous work and projects may be assessed to detect overlaps and deltas between skills of the developer of the subject code and potential peer reviewers. Connectivity may also be considered, based on high or low rework calculations between work products. Additionally, matching may be further based upon skill matrix overlaps or gaps, among other example considerations.

In some implementations, one or more repository systems (e.g., 115) may be provided, which interface with an example peer review selection system (e.g., 205) (for instance, through interfaces 235, 275). In one example, a repository system 115 may include one or more data processing apparatus (e.g., 262) and one or more memory elements (e.g., 264) for use in implementing executable modules, such as repository manager 265, user manager 270, and other examples. An example repository manager 260 may possess functionality to define and maintain repositories to track the development and changes to various code segments or components. For instance, a repository may be developed for each of several projects, with copies of the project code being stored together with modified versions of the code and other information to track changes, including proposed, rejected, accepted, and rolled-back changes to the project. As a repository may maintain code projects and code changes developed, owned, and otherwise by various users and organizations, user data may be generated and maintained (e.g., managed by user manager 270) to track persons responsible for these pieces of code and govern access and permissions for the various code components (e.g., 280) managed using the repositories hosted by the repository system 115.

In some implementations, a repository system 115 may enable social collaboration between developers using the repository system 115. For instance, as changes to a project (or source code component) are made, they may be proposed for adoption. This may trigger a workflow, managed by the repository system 115 where other users provide feedback regarding the proposed change. In some cases, additional data may be generated to document positive and negative feedback regarding various changes, which may relate to the rejection, adoption, or rollback of changes in various projects. Further, management and assignment of peer reviews of code components may also be performed in associations with one or more repositories (and may be documented, in some cases, in user data 285 and project data 290). In some implementations, events within a repository work flow may trigger an automated request (e.g., to peer review selection system 205) to determine a peer reviewer to facilitate such a flow. For instance, in some implementations, a “pull request” may be made in connection with a particular code component that embodies a repository branch. A pull request (or other similar requests) may include a request to assess the adoption of a particular code component within a project. In some cases, one or more peer reviews may be performed in response to a pull request. Accordingly, in such implementations, a pull request may prompt a peer review selection system 205 to autonomously identify one or more qualified peer reviewers for a corresponding code component. In other cases, a request to identify and select peer reviewers using a peer review selection system may be made outside of a repository system, pull request, or other structured flow, among other examples.

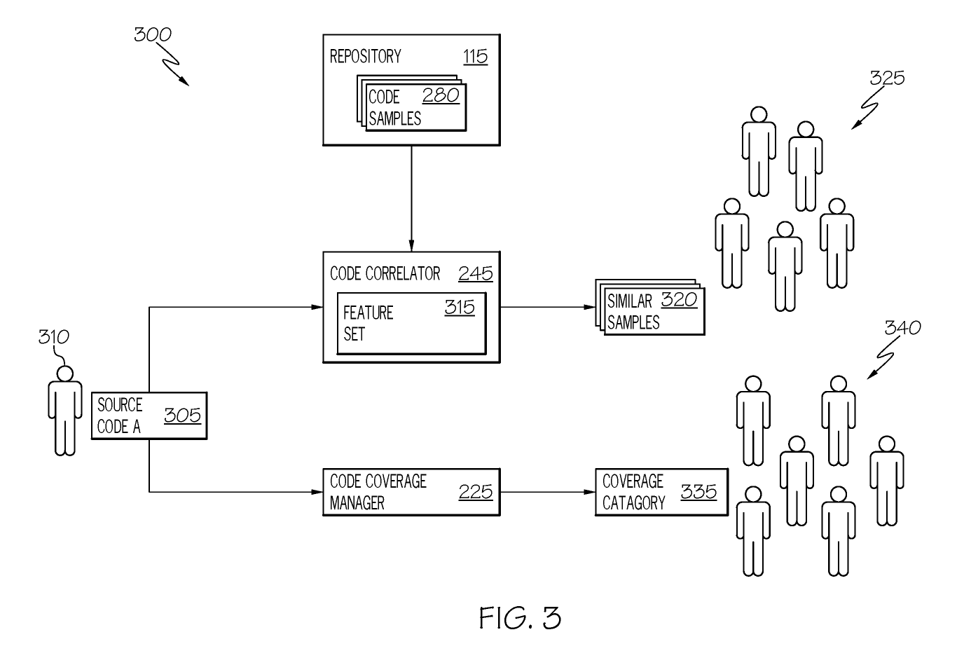

Turning to the example of FIG. 3, a simplified block diagram 300 is shown illustrating aspects of the autonomous selection of a peer reviewer for a particular code component (e.g., component 305). In this example, a particular user 310 (or group of users) is identified as responsible for a particular piece of code, or code component 305. The user 310 may be the developer of the code component 305. This code may be processed using a code correlator 245 and/or a code coverage manager 225 in connection with the autonomous identification of potential peer review candidates. Potential peer review candidates may be users other than the user 310 furnishing the subject code component (e.g., 305). In some instances, the universe of potential peer review candidates may be constrained by users within a particular organization (e.g., company, education or research institution, etc.), users registered with a particular repository service (e.g., GitHub™, etc.), users within a particular team or business unity within an organization, users within a particular geographical region, among other example constraints. In some examples, a code feature set (e.g., 315) may derived for the subject code component 305, the feature set corresponding to a set of characteristics descriptive of the style, format, language, purpose, functionality, conventions, etc. used in the subject code component 305. In some implementations, the feature set 315 may be implemented as a feature vector, which may be provided to a machine learning algorithm, among other examples. A code correlator can compare the characteristics of the subject code component 305 with a collection of the code components (e.g., 280) hosted, for instance, by one or more repository systems (e.g., 115), among other examples. The cord correlator (e.g., of an example peer review selection system) may determine a number of code components (e.g., 320) similar to the subject code component 305, on the basis of similarities between the feature set 315, or set of characteristics, of the subject code component 305 and these identified other code components (e.g., 320). This set of similar code components 320 may be associated with a subset of users (e.g., 325) representing potential peer review candidates. This group of users 325, rather than being selected based on arbitrary criteria (e.g., the users' seniority, management status, project assignments, etc.) may be selected based on their experience developing, managing, coding, debugging, etc. source code components (e.g., 320) which are coded similar to the subject code component 305. This can help ensure that peer reviewers are selected (e.g., from the identified group 325) who are more likely to make sense of the code before them and offer applicable insights. This can assist in not only improving the accuracy and efficacy of the peer review, but also the speed, given this group's familiarity and fluency with similar coding projects, among other example advantages.

Continuing with the example of FIG. 3, a code coverage manager 225 may also assess a subject piece of code (e.g., 305) and determine a subset of users (e.g., 340) in a collection of eligible users, who may also be beneficially selected as peer reviewers for the subject code component 305. However, in this example, rather than being selected on the basis of their expertise in similar coding projects (as would be determined using code correlator 245), code coverage manager 225 may seek to further the goal of expanding a team's code coverage exposure by selecting particular who could use exposure to a portion of a code base represented by the subject code 305. In some cases, the code component 305 may be a proposed change or modification to an existing component within a larger software system. In such instances, the code component 305 may be associated with a portion of the code base embodied by the existing component, which the subject component 305 effectively proposes to modify. In other cases, code coverage within a code base may be less granular, and may instead be defined by categories, which divide the code base in larger portions (e.g., each including multiple code components), such that “exposure” to a particular portion of the code base may be effectively satisfied through exposure to any one of the code components within that category or portion of the code base. For instance, such categories may map to individual modules, applications, products, business units, or other logical divisions, as may be defined in a variety of potential implementations. Accordingly, in either example, the code coverage manager 225 may parse the code component 305, or metadata of the code component 305, to identify a coverage category 335 within a given code base, which corresponds to the code component 305. Based on this determined coverage category 335, a number of potential peer reviewers (e.g., 340) may be determined who lack a threshold amount of exposure to code within the category and for which such exposure may be valued. In some cases, this may mean that these users (e.g., 340) possess no exposure to this category of code. In other cases, some of these users (e.g., 340) may have more than zero exposure, but all may have less than a satisfactory amount (e.g., as designated by a threshold amount) such that these users (e.g., 340) may be identified in connection with the coverage category 335 determination, among other examples.

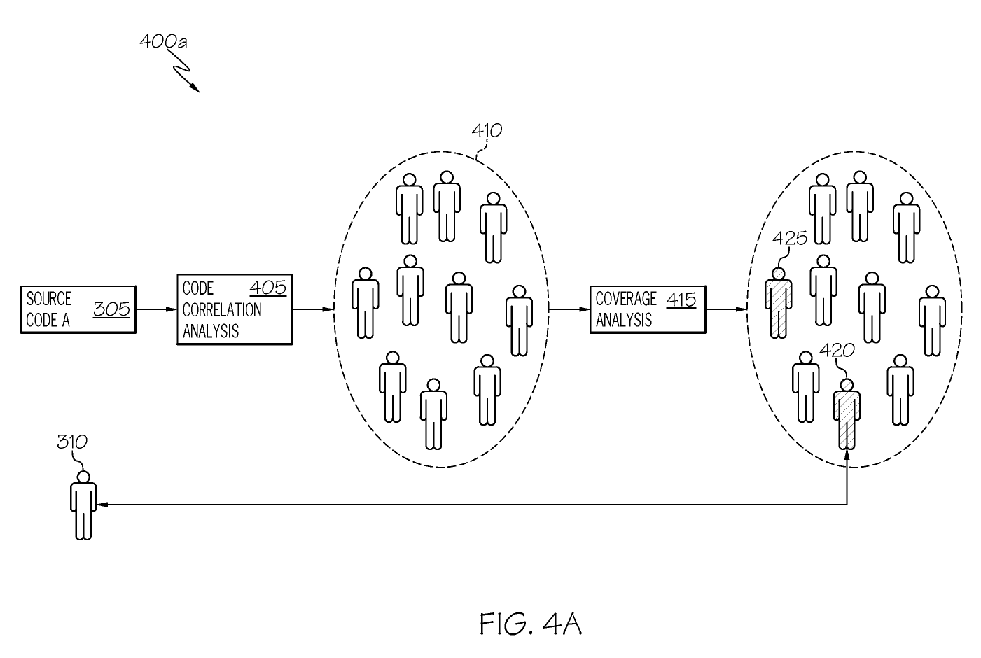

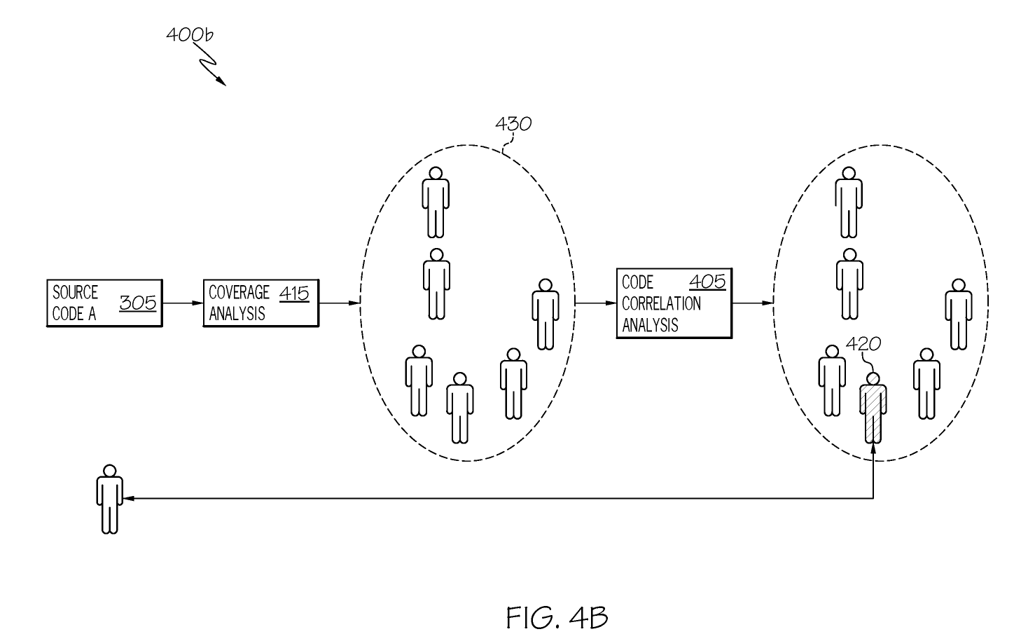

Turning to the examples of FIGS. 4A-4B, simplified block diagrams 400a-b illustrate example workflows, which may be adopted in connection with the autonomous matching of peer reviewers to a particular subject piece of code (e.g., 305). As noted in the example of FIG. 3, groups of candidate peer reviewers (e.g., 325, 340) may be identified through code correlation analysis and code coverage analysis, among other example processes. In some cases, members of these groups (e.g., 325, 340) may overlap, so as to further narrow the desired group of candidate peer reviewers who may be identified and assigned to conduct peer review tasks for the particular subject code component (e.g., 305).

In the example of FIG. 4A, a subject code component 305, authored by a particular user-developer 310 is provided for code correlation analysis 405 (e.g., to an example peer review selection system). The code correlation analysis 405 may identify other code components similar to the subject code components (e.g., on the basis of identified characteristics of the subject code component 305) and further identify a set of users (e.g., 410) who are associated with these other code components (e.g., developers/coders of the other code components). In some implementations, selection of one or more candidate peer reviewers may be determined following the code correlation analysis 405 from the identified set of users 410. In some instances, the other similar code components identified through the core correlation analysis 405 may be graded or scored based on their degree of similarity to the subject code component (e.g., 305). Accordingly, users associated with these identified other components may be likewise graded, such that the user with the highest grade or score is ranked as the top candidate to be the peer reviewer for the subject code. In some cases, other considerations may also factor into the selection of a particular peer reviewer, beyond their rank, such as the availability of the user (e.g., based on determining what, if any, other projects the user is participating as a peer reviewer), geography, affinity (e.g., based on common personal, occupational, cultural, linguistic, etc. traits), among other considerations.

In the example of FIG. 4A, upon detecting a set of one or more potential peer reviewer candidates 410 from a code correlation analysis involving a subject code component 305, further analysis may be performed to narrow the group of candidates, such as through a code coverage analysis 415 (e.g., performed using an example code coverage manager 225). In some cases, the code coverage analysis 415 may be considered a secondary or filtering analysis, and may be conditionally performed based on the results of the code correlation analysis 405 (e.g., with the number of the potential peer reviewer candidates determined from the code correlation analysis 405 is large enough (e.g., above a threshold number) to justify another level of analysis which may further narrow the number of candidates (e.g., through coverage analysis 415 or another type of analysis, such as discussed in the paragraph above)), among other examples. In the example of FIG. 4A, a coverage analysis 415 is performed based on the subject code component 305, but is limited to determine which of the candidates 410 determined from the code correlation analysis 405 would benefit, from the code base exposure perspective, in serving as the peer reviewer for the project. In this example, the group 410 is narrowed to identify two candidates 420, 425, determined from coverage analysis, to lack sufficient exposure to components in a category of a code base corresponding to the subject code component 305. In this example, a particular one of the candidates (e.g., 420) may be selected as the peer reviewer for the subject code and a peer review selection system may operate to notify the respective users (e.g., 310, 420) of their involvement in the project and to facilitate the selected peer reviewer's 420 participation in the project. In cases where more than one potential peer reviewer (e.g., 420, 425) is identified, such as in the particular example of FIG. 4A, additional criteria may be considered, such as the ranking of the respective users (e.g., based on the results of the code correlation analysis), availability of the users, geographical or linguistic proximity, cost of the user's participation in the peer review, among other factors.

Turning to the example of FIG. 4B, in an alternative implementation, rather than beginning an analysis by selecting a subset of users as potential peer reviewer candidates on the basis of a code correlation analysis 405 (as in the example of FIG. 4A), in other implementations, the first pass for screening potential peer reviewer candidates may involve a coverage analysis (or other criteria or analysis). In this example, analysis may begin with the code coverage analysis 415, with an initial grouping of potential candidates 430 being determined than was determined in the example of FIG. 4A, when code correlations 405 was initially performed. The code correlation analysis 405 may then be performed, such that the corpus of other code components considered (and analyzed) in the code correlation analysis is limited to those associated with the users (e.g., 430) identified in one or more previous analysis stages (e.g., the code coverage analysis 415), among other examples. In this example, this may result in the identification of the same “best” candidate (e.g., 420), although in other cases, changing the order of stages to screen potential peer review candidates may result in the selection of a different “best” candidate, among other example processes and implementations.

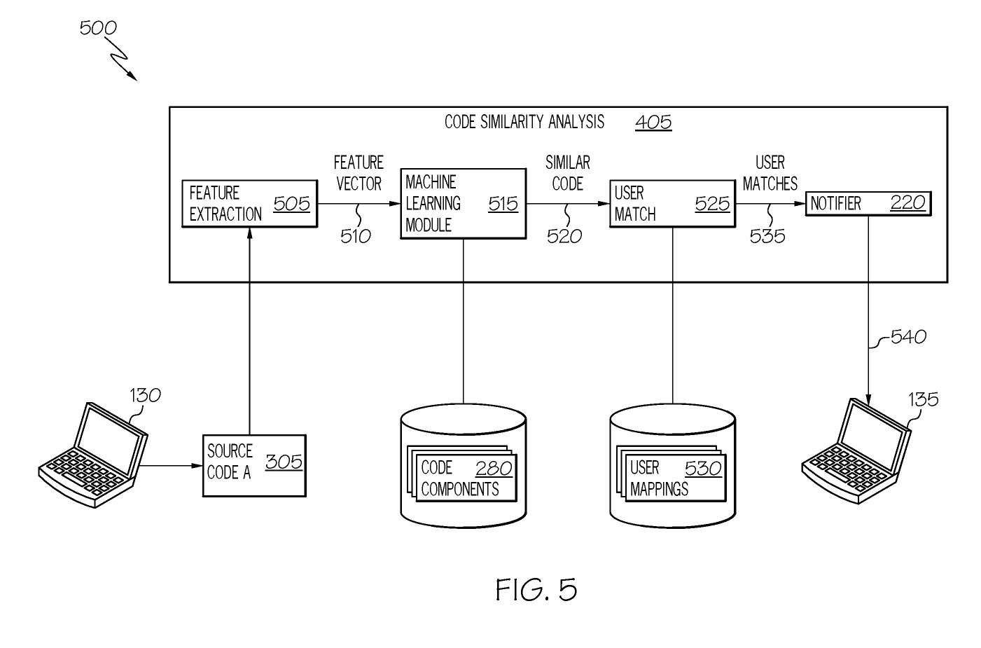

Turning FIG. 5, a simplified block diagram 500 is shown, illustrating aspects of one example implementation of a correlation analysis, such as discussed in the examples above. For instance, a code correlation analysis 405 may, itself, involve several stages and analyses. In this example, a user (e.g., using user device 130) may generate or develop a given code component (e.g., 305), which may be provided for processing in a code similarity analysis 480 performed at the direction of an example peer review selection system. For instance, a computing system, such as a system implementing a software development environment, a public or private repository, workflow management system, or other systems governing or used within a software development project or enterprise may identify that a particular code component (e.g., 305) is ready for peer review. Accordingly, a request may be sent to an example peer review selection system to select one or more peer reviewer candidates based on the characteristics of the source code within the subject component (e.g., 305). In some implementations, the request may include a copy of the subject code component itself, among other example implementations.

In the example of FIG. 5, autonomously selecting a peer review candidate may involve detecting other code components with similar characteristics as the subject code component 305. These characteristics may be selected based on their relevance to identifying other developers who are most likely to understand the code and provide insightful feedback for improving the subject code (e.g., given the relevance of their experience in other similar software coding projects). In one example, a set of characteristics may be defined and one or more processes may be carried out by an example computing system (e.g., implementing an example code analysis system (e.g., 210)) to autonomously discover each of the set of characteristics. For instance, during a feature extraction 505 phase of an example code correlation analysis 405, the code of the subject component 305 may be parsed to identify such characteristics as APIs used in the subject code, the language used in the subject code, a platform (e.g., a browser, third-party environment, etc.) for which the code is written or with which it is to operate, among other characteristics may be identified. Data filtering, text recognition, and other computer-performed discovery techniques may be utilized to discover such characteristics. Other characteristics may not be explicitly and objectively identifiable through parsing of the code, such as programming style, code layout tendencies, commenting style, naming conventions, functional flow patterns, and other example features. Such features, or characteristics, may instead be identified using specialized machine learning and heuristic identification models implemented, in some cases within specialized hardware of the code analysis system, among other example implementations. As an example, a number of defined values for a particular programming style characteristic may be defined and the particular programming style characteristic may be considered among the set of characteristics to be determined for the subject code component. Accordingly, a machine learning model, such as a neural network or decision tree forest (among other examples), may be trained to identify the particular programming style characteristic, and all or a portion of the code of the subject component 305 may be provided as an input to determine, using the machine learning model, which of the defined values most closely applies to the subject code component 305, among other examples.

A feature extraction stage 505 may be executed to output data describing the set of characteristics of the subject code component 305. In some implementations, characteristic set output may be embodied as a feature vector generated for the source code. The characteristic set data may be provided to additional stages in the code correlation analysis to determine a set of other code components with respective characteristics similar to those determined (at 505) for the subject code component. In one example, illustrated in FIG. 5, a feature vector 510 derived to describe the determined set of characteristics of the subject code component 305 may be provided to a machine learning module 515 (e.g., implemented using a machine learning model and supporting hardware, such as a neural network model, a random forest or other decision-tree model, a SVM-based model, among other examples) as an input. The machine learning module may identify, as an output, a group of other software components (e.g., 520) possessing characteristics similar to those identified in the feature vector. From these identified similar components 520, the code correlation analysis 405, in a user matching stage 525, may identify a set of users who correspond to (e.g., who developed, managed, or are otherwise familiar at the code level with) the identified similar components 520. Other stages (or no additional stage) may also be applied to determine one or more user matches 535 representing candidate peer reviewers autonomously selected based at least partially on correlations determined between the set of characteristics of the subject code component and other code (e.g., hosted or documented in a repository), among other examples. In some implementations, the determined user match data 535 may be provided to a notification utility (e.g., 220), which may automatically generate a corresponding invitation or assignment corresponding to and in response to the selection of a particular user as a peer reviewer. For instance, an electronic message (e.g., 540) may be automatically generated by the notification utility (e.g., 220) and sent to a user computer (e.g., 135) to notify the selected user of their selection as a peer reviewer for the subject code component (e.g., along with instructions for the peer review, a link to or copy of the code (or corresponding repository branch), among other example information).

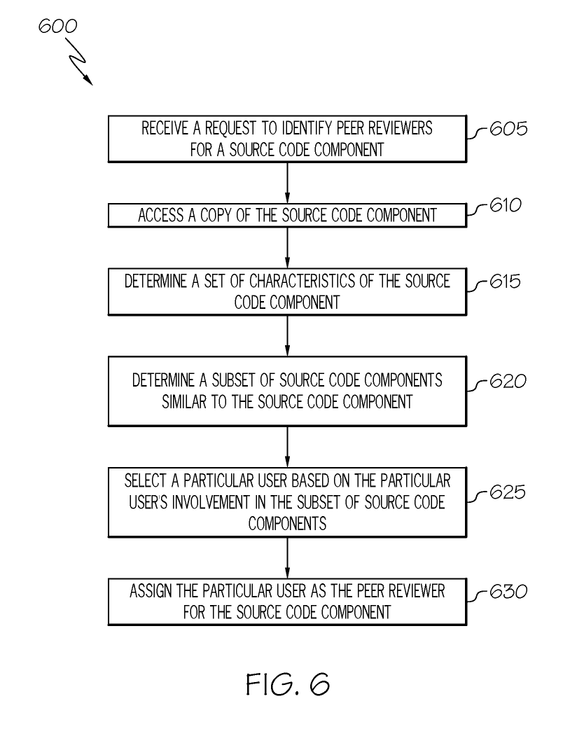

Turning to FIG. 6, a simplified flowchart 600 is presented illustrating example techniques for performing autonomous selection of a peer review candidate for a particular code component. For instance, a request may be received 605 at a peer review selection system to identify candidate peer reviewer candidates for a particular code component. The system may access 610 a copy of the code component (which, in some cases, may be linked to or appended to the code) and the system may autonomously determine 615 a set of characteristics of the source code component. The set of characteristics may then be used to determine 620 a subset of code components in a corpus of code components that possess characteristics similar to those determined (at 615) for the subject code component. Further, one or more particular users may be selected 625 based on these users' involvement with determined (at 620) the subset of code components. The particular user may be assigned 630 to peer review the subject code component based on the particular user's involvement in code components similar to the subject code component and in response to the request (received at 605), among other example implementations and features.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving a request for a computing system to automatically identify a peer reviewer for a particular source code component, wherein the particular source code component is authored by a first user;
accessing a copy of the particular source code component from computer memory;
detecting, using at least one data processing apparatus, a set of characteristics of the particular source code component;
analyzing, using at least one data processing apparatus, a library of source code components authored by a plurality of users other than the first user to determine that a subset of the library of source code components are similar to the particular source code component based on the set of characteristics;
determining, using at least one data processing apparatus, a particular one of the plurality of users as an author of one or more of the subset of source code components; and
presenting, using at least one data processing apparatus, the particular user as a peer review candidate for reviewing the particular software component based on determining that the particular user authored one or more of the subset of source code components.

2. The method of claim 1, wherein the request comprises the copy of the source code.

3. The method of claim 1, wherein the library of source code components is analyzed using a machine learning algorithm.

4. The method of claim 3, wherein the machine learning algorithm uses a random forest to identify the subset of source code components.

5. The method of claim 3, wherein the machine learning algorithm uses a neural network to identify the subset of source code components.

6. The method of claim 1, wherein one or more of the set of characteristics are identified using a machine learning algorithm, the particular source code component is provided as an input to the machine learning algorithm, and the set of characteristics comprise an output of the machine learning algorithm.

7. The method of claim 6, wherein the machine learning algorithm comprises a neural network algorithm.

8. The method of claim 6, wherein another one of the set of characteristics is identified using a non-machine learning algorithm.

9. The method of claim 1, wherein the set of characteristics comprises a plurality of different characteristics.

10. The method of claim 9, wherein one of the plurality of different characteristics comprises a programming language used in the particular source code component.

11. The method of claim 9, wherein one of the plurality of different characteristics comprises a programming style used by in the particular source code component.

12. The method of claim 9, wherein one of the plurality of different characteristics comprises application programming interfaces used in the particular source code component.

13. The method of claim 9, wherein one of the plurality of different characteristics comprises a type of project associated with the particular source code component.

14. The method of claim 1, further comprising:
determining, for each of the plurality of users, a respective amount of exposure to a code base of an organization;
determining that the source code corresponds to a particular portion of the code base; and
determining that the particular user lacks a threshold amount of exposure to code in the particular portion of the code base, wherein the particular user is presented as a peer review candidate for the project based at least in part on determining the particular user lacks the threshold amount of exposure to code in the particular portion of the code base.

15. The method of claim 14, wherein two or more of the plurality of other users are identified as authors of software components in the subset of software components, the two or more other users comprise the particular user, and the method further comprises:
selecting the particular user as the peer review candidate for reviewing the particular software component over another user in the two or more other users based on the particular user having less exposure to the particular portion of the code base than the other user in the two or more users.

16. The method of claim 1, further comprising:
generating an electronic notice assigning the particular user as the peer review candidate for reviewing the particular software component; and
sending the electronic notice to the particular user.

17. A non-transitory computer readable medium having program instructions stored therein, wherein the program instructions are executable by a computer system to perform operations comprising:
receiving a request for a computing system to automatically identify a peer reviewer for a particular source code component, wherein the particular source code component is authored by a first user;
accessing a copy of the particular source code component from computer memory;
analyzing the particular source code component to determine a set of characteristics of the particular source code component;
analyzing a plurality of source code components authored by a plurality of users other than the first user to determine a particular one of the plurality of users as authoring source code with characteristics similar to the set of characteristics; and
generating data to identify selection of the particular user as a peer review candidate for reviewing the particular software component.

18. A system comprising:
a data processing apparatus;
a memory;
a peer reviewer selection engine executable by the data processing apparatus to:
receive a request to automatically identify a peer reviewer for a particular source code component, wherein the particular source code component is authored by a first user;
access a copy of the particular source code component from the memory; and
a code analyzer executable by the data processing apparatus to:
detect a set of characteristics of the particular source code component;
analyzing a library of source code components authored by a plurality of users other than the first user to determine that a subset of the library of source code components are similar to the particular source code component based on the set of characteristics; and
determine a particular one of the plurality of users as an author of one or more of the subset of source code components; and
wherein the peer reviewer selection engine is further to generate data to identify selection of the particular user as a peer review candidate for reviewing the particular software component based on determining that the particular user authored one or more of the subset of source code components.

19. The system of claim 18, further comprising a repository system to manage the library of source code components.

20. The system of claim 18, wherein the code analyzer comprises machine learning hardware for use in one or both of detecting the set of characteristics and analyzing the library of source code.
